(19) United States
(12) Patent Application Publication
(10) Pub. No.: US 2009/0236815 A1
(43) Pub. Date: Sep. 24, 2009

(54) Ride on device with integral fluid dispensing system

(76) Inventor: Daniel S. O'Toole, Carmel, IN (US)

Correspondence Address: BOWMAN & ASSOCIATES, 1016 3rd Avenue, SW, Suite #106, CARMEL, IN, 46032, US

(21) Appl. No.: 12/077,851

(22) Filed: Mar. 21, 2008

(51) Int. Cl. B62J 11/02

(52) U.S. Cl. 280/201

(57) ABSTRACT

A ride on device such as a tricycle, big wheel, bicycle, three-wheeled bike or the like has an integral fluid dispensing system that enables the rider to disperse fluid into the atmosphere from a fluid reservoir formed internal to and within the frame of the ride on device through one or more spray nozzles. The spray nozzles are integral with the steering assembly of the ride on device and are predisposed to aim in cooperative with the direction of the steering assembly. An electric pump is utilized in cooperation with a power source to force the fluid from the internal fluid reservoir by actuation of a switch that is also disposed integral with the ride on device.

### BACKGROUND OF THE INVENTION

1. Field of the Invention

The present invention relates to a novelty ride-on device and, more particularly, to a ride on device having an internal fluid dispenser.

2. Background Information

The use of fluid dispersing systems in combination with various handheld and ride on devices is well known within the prior art. As may be appreciated, these devices have either been user add-on devices, self-contained unitary members that are not associated with a ride on device, or those which have not been manufactured as an integral member of the employing device. For example, U.S. Pat. No. 3,142,200 to Stillman sets forth a user add-on device which is a common squirt gun adapted to fit as a handle grip for a bicycle. This device offers a limited capacity reservoir and is manually operated by repeatedly depressing and releasing the trigger. Also, this device is not integral with the bicycle as it may be installed or removed at the user's discretion.

U.S. Pat. No. 4,209,113 to Kuna sets forth a manually operated pump which is detachably mounted upon the handlebars of a bicycle. When installed, this unitary device appears to be physically unstable upon the bicycle while the user is actuating the manually operated pump. The fluid reservoir is also very limited in capacity and is not integral with the bicycle.

U.S. Pat. No. 4,815,635 to Porter sets forth a manually operated pump which is detachably mounted to a bicycle which provides the rider with refreshment by offering a choice of more than one type of liquid for dispersement. This invention is an add-on device and features a manually operated diaphragm pump. Also, this device is not integral with the bicycle.

U.S. Patent Pub. No. US2006/0009114 A1 to Lau sets forth a reservoir and spray nozzle system mounted upon a ride on toy. The water is ejected from the reservoir through the spray nozzle by a mechanical pump which is actuated by a cam driven pump drive mounted upon the front drive wheel. The spray nozzle is not integral with the handlebars nor is the reservoir integral within the body of the ride on toy.

U.S. Pat. No. 5,474,486 to Chilton sets forth a remote control vehicle which includes an integral reservoir, an integral electric pump, and an integral spray nozzle. The operator of this device uses a remote control to activate the drive and spray mechanisms. While this device does contain some of the features taught by the instant invention, it does not feature an integral switch predisposed upon the device to activate the integral pump, nor is the spray mechanism integrated into a ride on device.

U.S. Pat. No. 6,959,838 to Eddins sets forth a handheld toy water gun with a reservoir and a manually operated pump which is predisposed to project a partial stream of water against a rotating absorbent member thereby creating a rapid fire sound as water is dispersed through the nozzle and into the atmosphere. Although this device does utilize a reservoir, a manually operated pump, an actuation means, and a spray nozzle, the device is not integral within a ride on device.

U.S. Pat. No. 7,032,837 to Eddins sets forth a handheld toy water gun with a reservoir and a manually operated pump which is predisposed to project a stream of water through a rotating nozzle. Although this device does utilize a reservoir, a manually operated pump, an actuation means, and a rotating spray nozzle, the device is not integral within a ride on device.

As such, it may be appreciated that there is ample room for improvement of ride on devices featuring a water dispersing system.

### SUMMARY OF THE INVENTION

In view of the foregoing known types of water dispersing systems now present in the prior art, the present invention provides a ride on device such as, but not limited to, a tricycle, bicycle, “big wheel” or other wheeled cycle or the like, which features an internal, integral and/or integrated fluid dispersing system. As such, the instant invention will be described subsequently in greater detail. The invention resides not in any one of these features per se, but rather in the particular combination of all of them herein disclosed and claimed and it is distinguished from the prior art in this particular combination of all of its structures for the functions specified.

According to the invention, there is provided a ride on device incorporating an integral fluid dispersing system. The integral fluid dispersing system comprises a fluid reservoir internal of and/or formed integrally with the frame of the ride on device and having one or more nozzles associated therewith through which the fluid in the internal fluid reservoir can be dispersed. A force device is associated with the fluid reservoir which is comprised of an electrical pump that is utilized to pull the fluid from the fluid reservoir and forcibly disperse the fluid through the nozzles upon actuation of a deployment means.

Preferably, the deployment means includes an actuator connected to electrical conduits and a power source which cooperatively energize the force device thereby causing the fluid within the fluid reservoir to be dispersed through the nozzles into the atmosphere.

In one form, the fluid reservoir is connected to the force device by means of one or more tubular conduits.

In one form, the nozzles are connected to the force device by means of one or more tubular conduits. Preferably the nozzles are incorporated into a front wheel yoke of the ride on device such that the nozzles point forward of the ride on device even during steering.

In one form, the nozzles are mountable on a front part of the ride on device.

In an alternate embodiment of the present invention, there is provided a ride on device as described above and additionally incorporating a rotatable nozzle which has a second electrical force means to rotate the rear rotating nozzle as fluid is being extracted from the fluid reservoir. In operation the rotatable nozzle sprays a “rooster tail” or circular spray pattern of fluid into the atmosphere.

The frame of the ride on device includes a steering mechanism having handle bars and a yoke incorporating a wheel, with one or more rear wheels attached thereto for running on a surface.

I have outlined, rather broadly, the more important features of the invention in order that the detailed description thereof that follows may be better understood, and in order that the present contribution to the art may be better appreciated. There are, of course additional features of the invention that will be described hereinafter and which will form the subject matter of the claims appended hereto. Those skilled in the art will appreciate the concept upon which this disclosure is based, and may readily be utilized as a basis for designing other structures, methods and systems for carrying out the purposes of the present invention. It is important, therefore, that the claims be regarded as including such equivalent constructions insofar as they do not depart from the spirit and scope of the present invention.

These together with objects of the invention, along with the various features of novelty which characterize the invention, are pointed out with particularity in the following description and claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The above mentioned and other features, advantages and objects of this invention, and the manner of attaining them, will become apparent and the invention itself will be better understood by reference to the following description of embodiments of the invention taken in conjunction with the accompanying drawings, wherein:

FIG. 1 is an elevated orthographic view of a ride on device embodying the present invention illustrating the various parts, their configuration and relationship;

FIG. 2 is an elevated orthographic view of the ride on device of FIG. 1, particularly illustrating the relationship between internal fluid reservoir and the steering mechanism;

FIG. 3 is a frontal orthographic view of the ride on device of FIG. 1, illustrating the various parts, their configuration and relationship;

FIG. 4 is a rear orthographic partial view of the ride on device of FIG. 1 illustrating the relationship between an optional rotating nozzle and the rear assembly of the ride on device; and

FIG. 5 is a block diagram of the components which comprise the instant invention.

Like reference numerals indicate the same or similar parts throughout the several figures.

A discussion of the features, functions and/or configuration of the components depicted in the various figures will now be presented. It should be appreciated that not all of the features of the components of the figures are necessarily described. Some of these non discussed features as well as discussed features are inherent from the figures. Other non discussed features may be inherent in component geometry and/or configuration.

### DETAILED DESCRIPTION OF EMBODIMENTS OF THE INVENTION

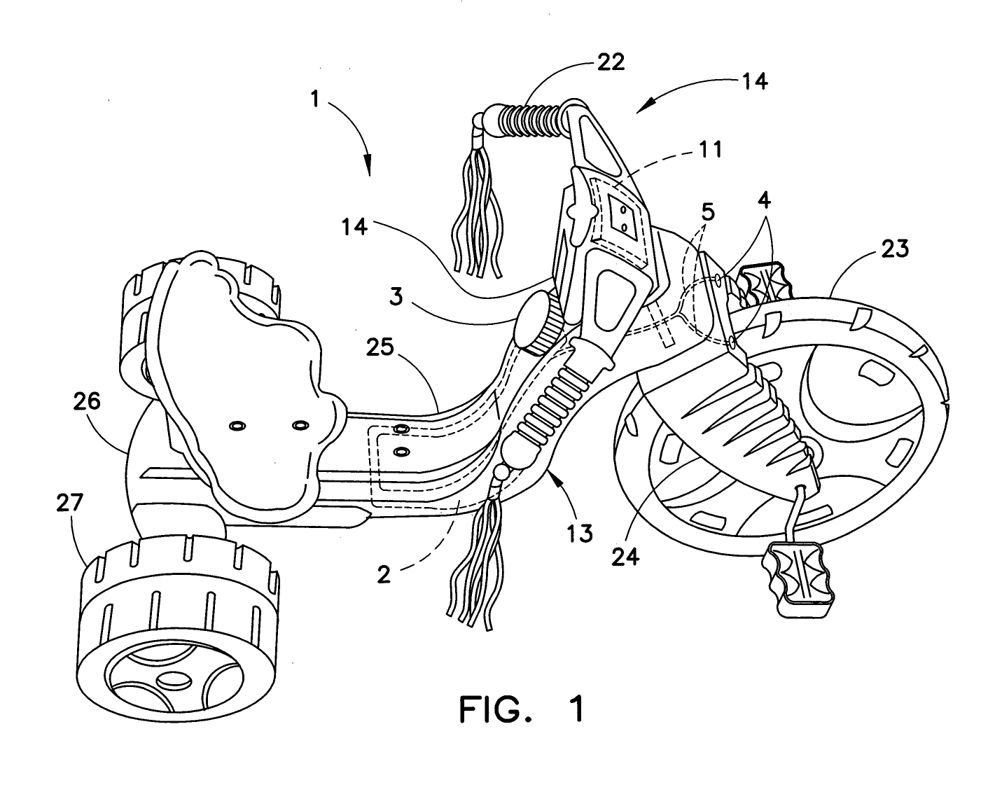

With reference to the drawings, and in particular to FIGS. 1,2, and 3, a new and improved ride on device 1 embodying the principles and concepts of the present invention will be described. It will be noted that the ride on device 1 is comprised mainly of a frame 13 which is further comprised of a body 25 and a steering assembly 14, with the steering assembly 14 being further comprised of a yoke 24, a wheel 23, and handlebars 22. The frame 13 is preferably, but not necessarily, made or molded from plastic. Other materials, however, may be used.

The body 25 internally houses a fluid reservoir 2 (an internal fluid reservoir) that is preferably, but not necessarily, integrally molded, formed or made in conjunction with and/or into the body 25. The fluid reservoir 2 may be delineated, however, after formation of the body 25. The fluid reservoir 2 incorporates an integral force device embodied as a pump 6 which draws fluid (such as water) from the reservoir 2 through a pick up orifice member 15. Upon employment of the pump 6, the fluid (via the vacuum suction created by operation of the pump 6) enters the pick up orifice member 15 and travels to the low pressure side of a pump 6 where it is pressurized and discharged into a discharge orifice member 5. Although the instant invention utilizes a single discharge orifice member 5 and a single pump 6, it would be acceptable to implement more than one discharge orifice member 5 from a single pump 6 or from multiple pumps. The discharge orifice member 5 travels through an orifice in the reservoir 2 to one or more front spray nozzles 4 which are integrally positioned within the steering assembly 14. The steering assembly 14 is integrally fitted into the body 25 thereby forming the ride on device 1. The steering assembly 14 is engaged within the body 25 in a manner which allows rotational movement of the steering assembly 14 in relation to the body 25. Due to said rotation of the steering assembly 14, the discharge orifice members 5 must be a least partially flexible. The rear wheels 27 attach to the rear portion 26 of the body 25 in a manner which allows their rotational movement.

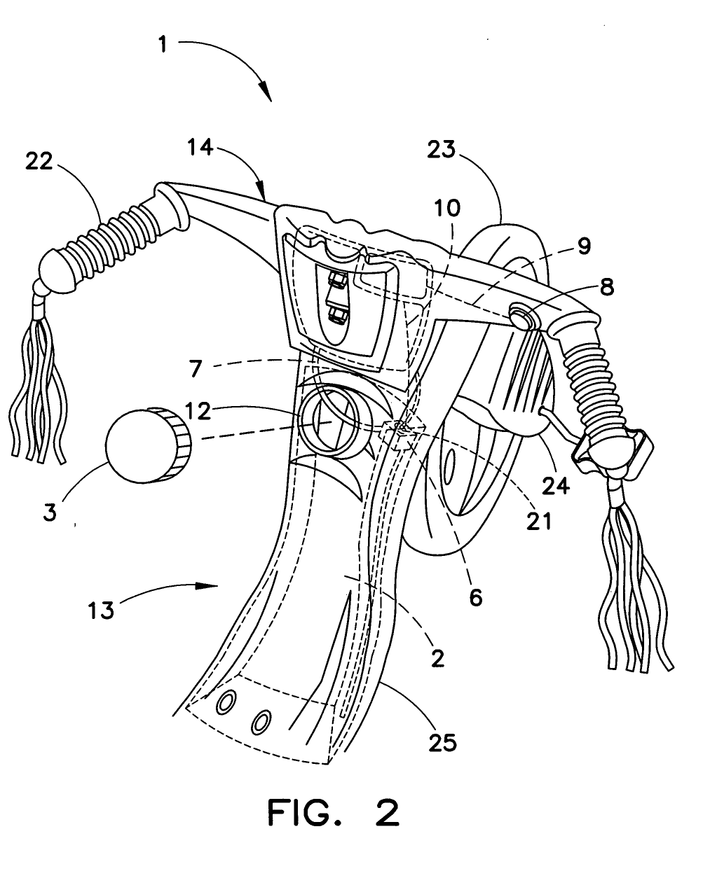

Referring to FIG. 2, the body 25 has a fill aperture 12 in communication with the reservoir 2 which is utilized to fill the reservoir 2 with fluid. A demountable fill cap 3 when engaged upon the fill aperture 12 creates an acceptable seal between the fill aperture 12 and the cap 3. When the cap 3 is in a demounted position, access to the reservoir 2 is possible for filling with fluid.

The pump 6 is operated by a power source 11 (see FIG. 1) and an intermittent switch 8 located in an integral manner upon the steering assembly 14. Although in the current preferred embodiment the intermittent switch 8 is located upon the steering assembly 14, the intermittent switch 8 could alternatively be located upon the body 25.

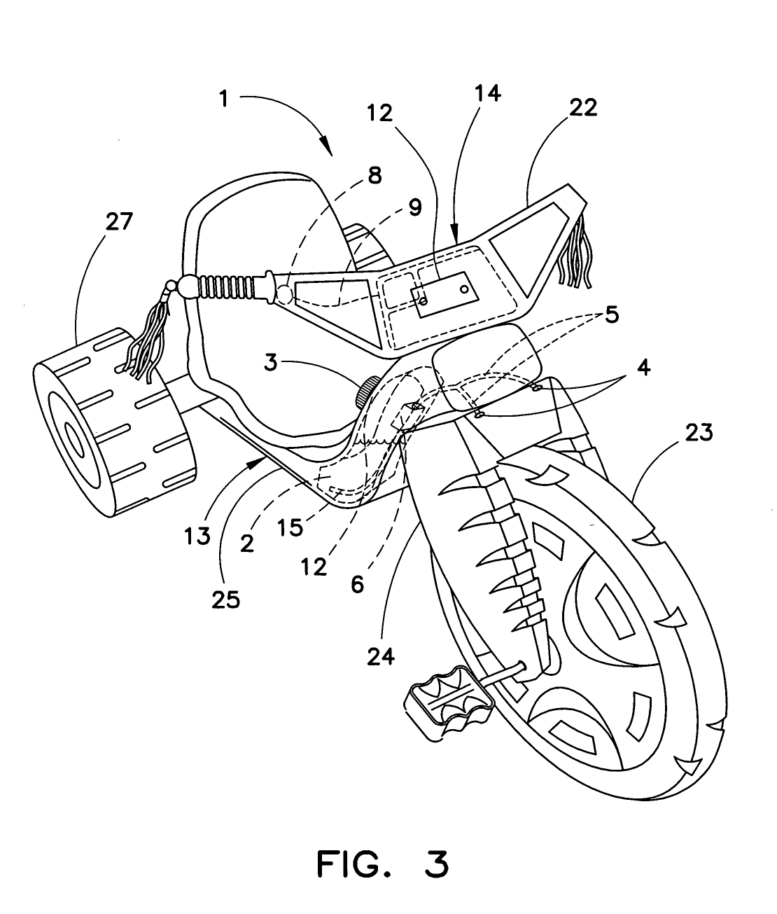

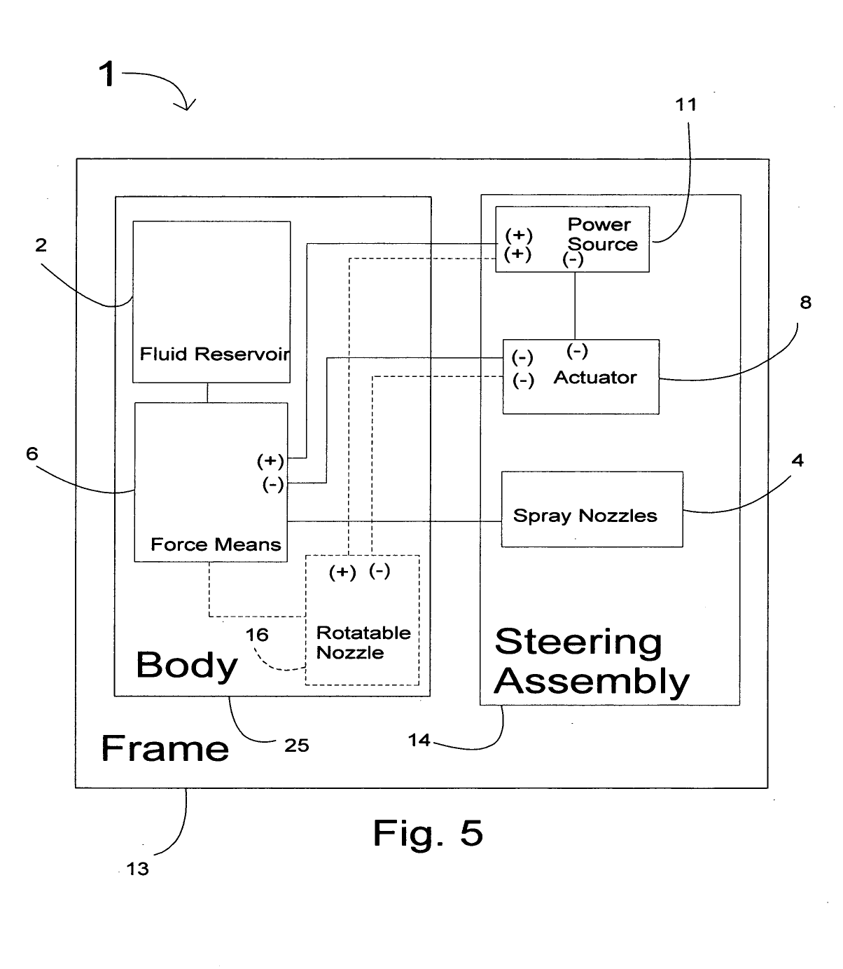

Referring to FIGS. 1, 2, 3 and 5, in the instant invention the power source 11 is comprised of common dry cell batteries of a suitable voltage required to operate the pump 6. It would also be acceptable for the pump 6 to be powered by other suitable portable energizing means. The current preferred embodiment carries the power source 11 within the steering assembly 14. It would be equally acceptable for the power source 11 to be carried within the body 25. Referring specifically to FIG. 5, the positive or negative lead terminal of the power source 11 is wired directly to corresponding negative or positive lead terminal of the pump 6. The other wire lead from the power source 11 is wired to one of the intermittent switch's 8 contacts, and the other intermittent switch 8 contact (typically an on/off switch has two contacts) is connected to the other contact upon the pump 6 that was not previously wired directly to the power source 11. To operate the pump 6 the rider would depress the intermittent switch 8 thereby completing/closing the electrical circuit between the power source 11 and the pump 6. As previously stated, in operation the pump 6 would evacuate fluid from the reservoir 2 through the pickup orifice member 15, pressurize the fluid and send it through the discharge orifice member 5 which transfers the fluid to one or more front spray nozzles 4. At that point the front spray nozzles 4 discharge the fluid into the atmosphere in the corresponding direction in which the steering assembly 14 is pointed and/or steered.

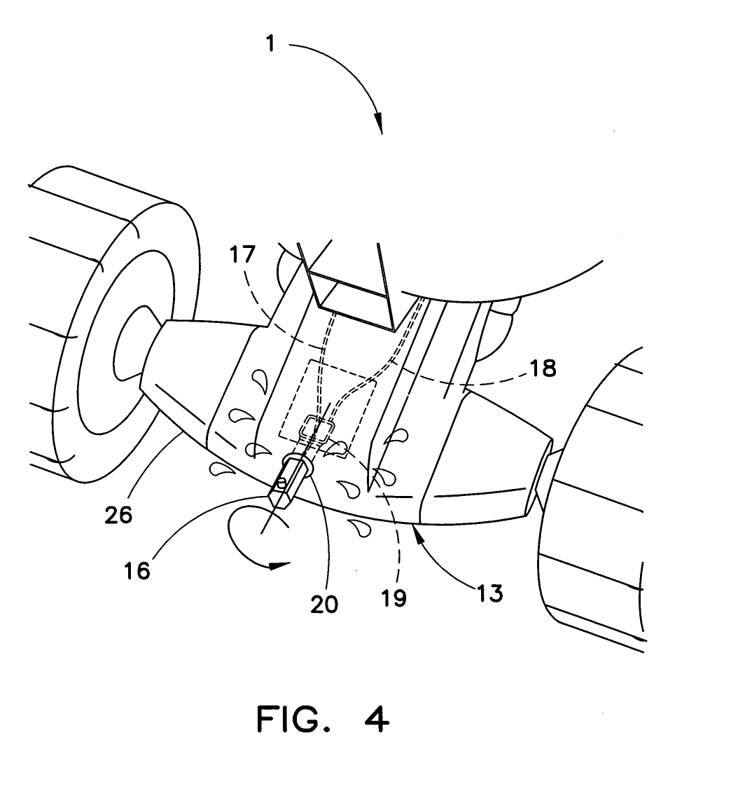

Referring to FIG. 4, an optional spray feature of the present invention is incorporated within the rear 26 of the body 25. The rear rotatable spray nozzle 16 projects through a rear aperture 20 which is sized to allow unobstructed rotation of the rear rotatable spray nozzle 16.

The rear rotatable spray nozzle 16 and rear electrical motor 19 are constructed as a unitary member and displaced within the body 25, wherein the rear electrical motor 19 when operational causes the rear rotatable spray nozzle 16 to rotate. When operational, the rear rotatable spray nozzle 16 and the front spray nozzles 4 receive pressurized fluid directly from the discharge orifice member 5. Upon depressing the intermittent switch 8, the pump 6 and the rear electrical motor 19 become operational thereby rotating the rear rotating spray nozzle 16 in a continuous circular motion thus creating a circular spray pattern of the fluid evacuated from the reservoir 2.

In the instant invention the rear rotatable spray nozzle 16 (along with the rear electrical motor 19) and the front spray nozzles 4 share the power source 11, intermittent switch 8, pump 6, pickup orifice member 15, discharge orifice member 5, and reservoir 2. Alternatively the rear rotatable spray nozzle 16 and the rear electrical motor 19 could share less than all of the components which comprise the front discharge mechanism (the pump 6, power source 11, reservoir 2, discharge orifice member 5, pickup orifice member 15, and intermittent switch 8), whereby upon by depressing separate intermittent switches (including the intermittent switch 8) the front spray nozzles 4 and the rear rotatable spray nozzle 16 operate as independent systems.

It should be appreciated that the principles of the present invention apply to all types of ride on devices other that the tricycle or big wheel shown in the figures. As such, the present invention may be incorporated or made into a bicycle, a three-wheeled bike or the like. Therefore, the term ride on device is deemed to encompass these other types of cycles and wheeled ride on devices.

While the invention has been illustrated and described in detail in the drawings and foregoing description, the same is to be considered as illustrative and not restrictive in character, it being understood that a preferred embodiment has been shown and described and that all changes and modifications that come within the spirit of the invention are desired to be protected.

What is claimed is:

1. A ride on device with an integral fluid dispersing system, the ride on device comprising:
a frame;
a plurality of wheels rotatably carried by the frame;
a fluid reservoir formed integral with the frame;
a force means in communication with the fluid reservoir and adapted to force fluid from the fluid reservoir;
a spray nozzle carried by the frame and in communication with the force means by a fluid conduit; and
an actuation means in communication with the force means and operable to operationalize the force means whereby fluid from the fluid reservoir is supplied to and dispersed from the spray nozzle.

2. The ride on device of claim 1, wherein the force means comprises an electric pump and a power source, the actuation means electrically coupled between the power source and the electric pump whereby actuation of the actuation means disperses the fluid from the fluid reservoir from the nozzle.

3. The ride on device of claim 2, wherein the electric pump is disposed within the fluid reservoir.

4. The ride on device of claim 2, wherein the actuation means comprises an intermittent switch.

5. The ride on device of claim 1, wherein the frame includes a yoke and a handlebar assembly coupled to the yoke, the yoke rotatably carrying a wheel, the yoke carrying the nozzle.

6. The ride on device of claim 5, further comprising a second nozzle carried by the yoke and in communication with the force means by a second fluid conduit.

7. The ride on device of claim 1, further comprising a rotatable nozzle carried on a rear portion of the frame and in communication with the force means by a rear fluid conduit whereby fluid from the fluid reservoir is supplied to the rotatable nozzle for dispensing the fluid from the rotatable nozzle.

8. The ride on device of claim 7, further comprising an electric motor in communication with the actuation means and in communication with the rotatable nozzle for rotating the rotatable nozzle whereby the electric motor rotates the rotatable nozzle upon actuation of the actuation means and the fluid from the fluid reservoir is supplied to the rotatable nozzle.

9. A ride on device with an integral fluid dispersing system, the ride on device comprising:
a frame;
a plurality of wheels rotatably carried by the frame;
a fluid reservoir formed internal to the frame;
a force means in communication with the fluid reservoir and adapted to force fluid from the fluid reservoir;
a spray nozzle carried by the frame and in communication with the force means by a fluid conduit; and
an actuation means in communication with the force means and operable to operationalize the force means whereby fluid from the fluid reservoir is supplied to and dispersed from the spray nozzle.

10. The ride on device of claim 9, wherein the frame is formed of plastic.

11. The ride on device of claim 10, wherein the force means comprises an electric pump and a power source, the actuation means electrically coupled between the power source and the electric pump whereby actuation of the actuation means disperses the fluid from the fluid reservoir from the nozzle.

12. The ride on device of claim 11, wherein the electric pump is disposed within the fluid reservoir.

13. The ride on device of claim 11, wherein the actuation means comprises an intermittent switch.

14. The ride on device of claim 10, wherein the frame includes a yoke and a handlebar assembly coupled to the yoke, the yoke rotatably carrying a wheel, the yoke carrying the nozzle.

15. The ride on device of claim 14, further comprising a second nozzle carried by the yoke and in communication with the force means by a second fluid conduit.

16. The ride on device of claim 10, further comprising a rotatable nozzle carried on a rear portion of the frame and in communication with the force means by a rear fluid conduit whereby fluid from the fluid reservoir is supplied to the rotatable nozzle for dispensing the fluid from the rotatable nozzle.

17. The ride on device of claim 16, further comprising an electric motor in communication with the actuation means and in communication with the rotatable nozzle for rotating the rotatable nozzle whereby the electric motor rotates the rotatable nozzle upon actuation of the actuation means and the fluid from the fluid reservoir is supplied to the rotatable nozzle.

18. A ride on device with an integral fluid dispersing system, the ride on device comprising:
a plastic frame defining a body and a steering assembly;
a front wheel rotatably carried by the steering assembly;
a pair of rear wheels rotatably carried by the body;
a fluid reservoir formed internal to the body;
a fluid pump in communication with the fluid reservoir and adapted to force fluid from the fluid reservoir;
first and second spray nozzles carried by the steering assembly and in communication with the fluid pump by a respective first and second fluid conduit; and
an actuation means in communication with the fluid pump and operable to operationalize the fluid pump whereby fluid from the fluid reservoir is supplied to and dispersed from the first and second spray nozzles.

19. The ride on device of claim 18, wherein the fluid pump is disposed within the fluid reservoir.

20. The ride on device of claim 18, further comprising a rear nozzle carried on a rear portion of the body rotatably connected to a rear electric motor in communication with the actuation means, the rear nozzle in communication with the fluid pump by a rear fluid conduit whereby fluid from the fluid reservoir is supplied to the rotatable nozzle for dispensing the fluid from the rotatable nozzle and the electric motor rotates the rotatable nozzle upon actuation of the actuation means
